(19) United States
(12) Patent Application Publication
(10) Pub. No.: US 2003/0085682 A1
(43) Pub. Date: May 8, 2003

(54) Motor control circuit which reduces current transients at commutation state transitions

(75) Inventor: Hakam D. Hussein, Eagan, MN (US)

Correspondence Address: FELLERS,SNIDER,BLANKENSHIP,BAILEY & TIPPENS, P.C., BANK ONE TOWER, 100 NORTH BROADWAY, SUITE 1700, OKLAHOMA CITY, OK, 73102-8820, US

(73) Assignee: Seagate Technology LLC, Scotts Valley, CA

(21) Appl. No.: 10/187,037

(22) Filed: Jun. 28, 2002

Related U.S. Application Data
(60) Provisional application No. 60/345,945, filed on Nov. 7, 2001.

(51) Int. Cl. G05B 11/28

(52) U.S. Cl. 318/599

(57) ABSTRACT

A motor control circuit which applies current to a multiphase spindle motor. The spindle motor comprises a plurality of phases and preferably supports a data storage disc of a data storage device. The motor control circuit comprises a sense resistor connected to the voltage source, a plurality of upper switching elements each connected in series between the sense resistor and a different one of the phases of the spindle motor, and a plurality of lower switching elements each connected in series between a different one of the phases of the spindle motor and a reference terminal having a second potential lower than the first potential. A driver circuit selectively applies control signals to the switching elements to apply the desired magnitude of current from the voltage source, through the sense resistor and to the spindle motor.

### RELATED APPLICATIONS

This application claims priority to Provisional Application No. 60/345,945 Filed Nov. 7, 2001.

### FIELD THE INVENTION

The claimed invention relates generally to the field of electric motor devices and more particularly, but not by way of limitation, to an apparatus for preventing audible noise and current transients in a disc drive spindle motor.

### BACKGROUND

A disc drive is a data storage device used to store digital data. A typical disc drive includes a number of rotatable magnetic recording discs that are axially aligned and mounted to a spindle motor for rotation at a high constant velocity. A corresponding array of read/write heads access tracks defined on the respective disc surfaces to write data to and read data from the discs.

Disc drive spindle motors are typically provided with a three-phase, direct current (dc) brushless motor configuration. The phase windings are arranged about a stationary stator on a number of radially distributed poles. A rotatable spindle motor hub is provided with a number of circumferentially extending permanent magnets in close proximity to the poles. Application of current to the windings induces electromagnetic fields that interact with the magnetic fields of the magnets to apply torque to the spindle motor hub and induce rotation of the discs.

Early disc drive spindle motor designs used Hall effect or similar external sensors to provide an independent indication of motor positional orientation. However, present designs avoid such external sensors and instead use electronic commutation and back electromagnetic force (bemf) detection circuitry to provide closed-loop spindle motor control. Such approach generally entails applying a predetermined sequence of commutation steps to the phase windings of the spindle motor over each electrical revolution (period) of the motor. A commutation step involves supplying the motor with current to one phase, sinking current from another phase, and holding a third phase at a high impedance in an unenergized state.

Detection circuitry measures the bemf generated on the unenergized phase, compares this voltage to the voltage at a center tap of the windings, and outputs a signal at a zero crossing of the voltages; that is, when the bemf voltage changes polarity with respect to the voltage at the center tap. The point at which the zero crossing occurs is then used as a reference for the timing of the next commutation pulse, as well as a reference to indicate the position and relative speed of the motor.

At the commutation switching points the prior art generates glitching in both motor and power supply currents. This phenomenon creates undesirable audible noise and destabilizes the power supply. Some power supplies go into current limiting mode due to the lack of output current capability.

Accordingly, there is a need for improvements in the art whereby a high performance spindle motor can be reliably controlled up to an operational velocity, and it is to such improvements that the claimed invention is directed.

### SUMMARY OF THE INVENTION

In accordance with preferred embodiments, a motor control circuit is provided to apply current to phases of a multiphase spindle motor. The motor control circuit comprises a sense resistor connectable to a voltage source having a first potential.

A plurality of upper switching elements are each connected in series between the sense resistor and a different one of the phases of the spindle motor. A plurality of lower switching elements are each connected in series between a different one of the phases of the spindle motor and a reference terminal having a second potential lower than the first potential.

A driver circuit selectively applies control signals to the switching elements to establish a flow of current from the voltage source, through the sense resistor and to the spindle motor. The control signals are preferably generated in relation to a voltage sensed across the sense resistor.

A commutation circuit is preferably used to electrically commutate the spindle motor over a plurality of commutation states, wherein the control signals are selected in relation to each commutation state. A back electromotive force (bemf) detection circuit preferably detects bemf from the spindle motor and the commutation circuit selects a commutation state in relation to the detected bemf.

The switching elements each preferably comprise a field effect transistor (FET) having a source, a drain and a gate, and wherein the control signals are provided to the gates of the FETs to control source-drain conductivity of said FETs.

The flow of current is preferably passed from the voltage source, through the sense resistor, through a selected upper switching element, through a first phase of the spindle motor associated with the selected upper switching element, through a second phase of the spindle motor, through a selected lower switching element associated with the second phase, and to the reference terminal. Tile first potential preferably comprises a positive voltage and the second potential of the reference terminal preferably comprises substantially zero volts (i.e., ground).

Because the sense resistor is disposed between the voltage source and the motor, all of the current flowing through the motor passes through the sense resistor, and hence can be controlled. This generally reduces the occurrence of transients (spikes) in the applied current, improving operational reliability and reducing the potential for damage to the motor and to the voltage source.

These and various other features and advantages which characterize preferred embodiments of the present invention will be apparent from a reading of the following detailed description and a review of the associated drawings.

### BRIEF DESCRIPTION OF THE DRAWINGS

FIG. 1 is a top plan view of a disc drive constructed in accordance with preferred embodiments of the present invention.

FIG. 2 provides a functional block diagram of the disc drive of FIG. 1.

FIG. 3 provides a schematic representation of a prior art motor driver circuit used to rotate a spindle motor.

FIG. 4 provides a graphical representation of current signals obtained during a start mode of the prior art circuit of FIG. 3.

FIG. 5 provides a graphical representation of current signals obtained during a run mode of the prior art circuit of FIG. 3.

FIG. 6 provides a schematic representation of the motor control circuit of FIG. 2 in conjunction with the spindle motor of FIG. 1.

FIG. 7 provides a graphical representation of current signals obtained during a start mode of the new invention embodied in the circuit of FIG. 6.

FIG. 8 provides a graphical representation of current signals obtained during a run mode of the new invention embodied in the circuit of FIG. 6.

### DETAILED DESCRIPTION

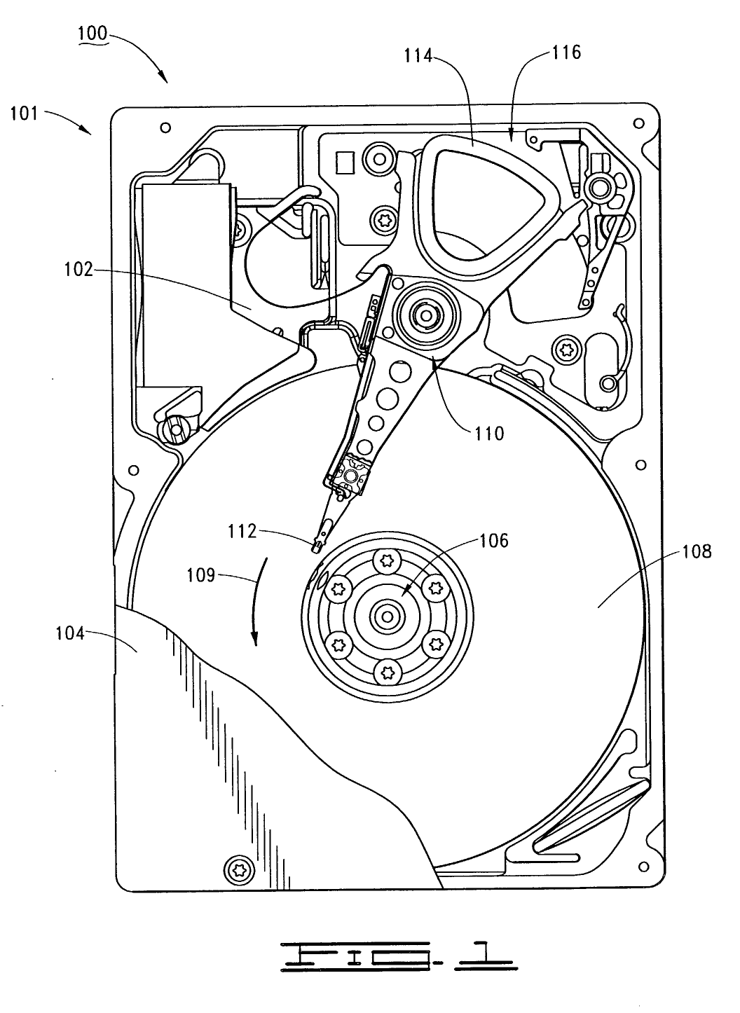

FIG. 1 provides a top plan view of a disc drive 100 constructed in accordance with preferred embodiments of the present invention. A base deck 102 and a top cover 104 (shown in partial cutaway) cooperate to form a sealed housing for the disc drive 100. A spindle motor 106 rotates a number of magnetic recording discs 108 in a rotational direction 109. An actuator assembly 10 supports an array of read/write heads 112 adjacent the respective disc surfaces. The actuator assembly 110 is rotated through the application of current to an actuator coil 114 of a voice coil motor (VCM) 116.

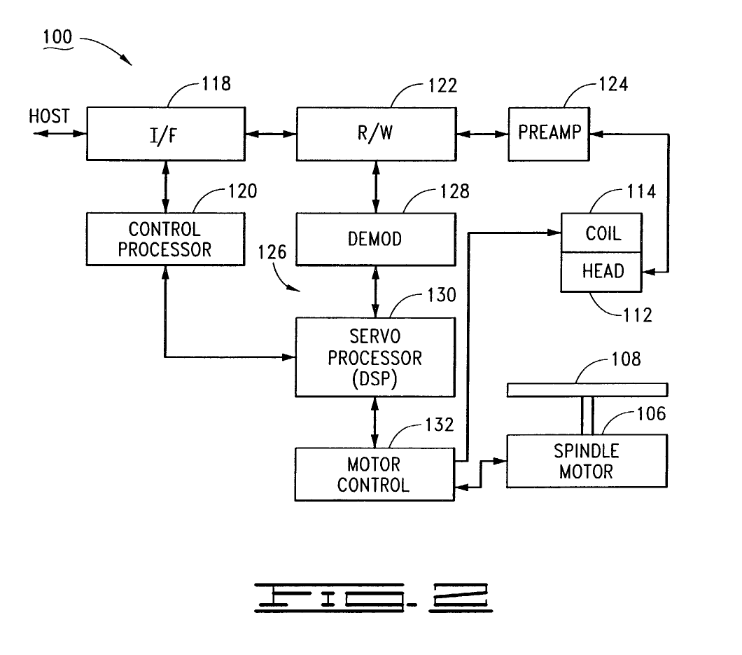

FIG. 2 provides a functional block diagram of the disc drive 100. FIG. 2 includes control circuitry provided on a disc drive printed circuit board (PCB) affixed to the underside of the disc drive 100, and thus not visible in FIG. 1.

Data and host commands are provided from a host device to the disc drive 100 using interface (I/F) circuitry 118 in conjunction with a top level control processor 120. Data are transferred between the discs 108 and the host device using the I/F circuitry 118, a read/write (R/W) channel 122, and a preamplifier/driver (preamp) circuit 124.

Head positional control is provided by a closed-loop servo circuit 126 comprising demodulation (demod) circuitry 128, a servo processor 130. The servo processor preferably comprises an ARM (advanced RISC (reduced instruction set computer) machine) device and motor control circuitry 132. The motor control circuitry 132 applies drive currents to the actuator coil 114 to rotate the actuator 110. The motor control circuitry 132 further applies drive signals to the spindle motor 106 to rotate the discs 108.

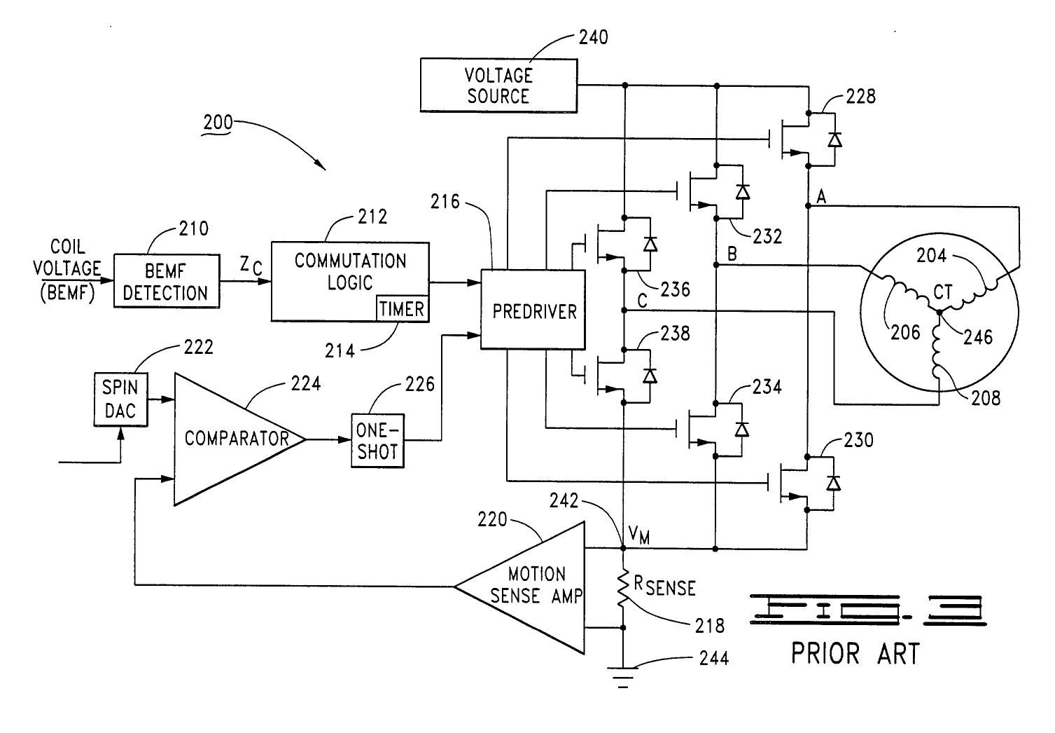

FIG. 3 provides a functional block diagram of relevant portions of a prior art motor driver circuit 200 in conjunction with a spindle motor 202 substantially similar to the spindle motor 106 of FIG. 1. The driver circuit 200 applies drive currents to A, B and C windings (phases) 204, 206 and 208 of the spindle motor 202 over a number of sequential commutation steps to rotate the motor. Generally during each commutation step current is applied to one phase, sunk from another phase, and a third phase is held at a high impedance in an unenergized state.

Back electromotive force (bemf) detection circuitry 210 measures the bemf generated on the unenergized phase, compares this voltage to the voltage at a center tap, and outputs a zero crossing (Zc) signal when the bemf voltage changes polarity with respect to the voltage at the center tap. A commutation circuit 212 uses the Zc signals to time the application of the next commutation step using a timer 214.

Spindle driver circuitry 216 (predriver circuitry) includes predriver and rotor position sense (RPS) circuitry to detect electrical position of the spindle motor 202 in a manner to be discussed shortly. At this point it will be noted that the RPS circuitry 216 includes a sense resistor R_{SENSE} 218, a motion sense amplifier 220, a digital to analog converter (DAC) 222, a comparator 224 and a one shot element 226. FIG. 3 also shows six field effect transistors (FETs) 228, 230, 232, 234, 236 and 238, with inputs denoted as AH (A high), AL (A low), BH, BL, CH and CL, respectively. Controlled, timed application of drive currents to the various FETs result in flow of current through the A, B and C phase windings 204, 206 and 208 from a voltage source 240 to V_{M} node 242, through the R_{SENSE} sense resistor 218 to reference terminal (ground) 244. Spindle motor commutation steps (states) are defined in Table 1:

TABLE 1

| Commulation | Source | Sink | Phase Held at |
|---|---|---|---|
| State | Phase | Phase | High Impedance |
| 1 | A | B | C |
| 2 | A | C | B |
| 3 | B | C | A |
| 4 | B | A | C |
| 5 | C | A | B |
| 6 | C | B | A |

During commutation step 1, phase A (winding 204) is supplied with current, phase B (winding 206) outputs (sinks) current, and phase C (winding 208) is held at high impedance. This is accomplished by selectively turning on AH FET 228 and BL FET 234, and turning off AL FET 230, BH FET 232, CH FET 236 and CL FET 238. In this way, current flows from the voltage source 240, through the AH FET 228, through the A phase winding 204, through the center tap (CT node 246), through the B phase winding 206, through the BL FET 234 to the V_{M} node 242, and through the R_{SENSE} sense resistor 218 to ground 244.

The resulting current flow through the A and B phase windings 204 and 206 induce electromagnetic fields which interact with a corresponding array of permanent magnets (not shown) mounted to the rotor (spindle motor hub), thus inducing a torque upon the spindle motor hub in the desired rotational direction. The appropriate FETs are sequentially selected to achieve the remaining commutation states shown in Table 1.

It will be noted that each cycle through the six commutation states of Table 1 comprises one electrical revolution of the motor. The number of electrical revolutions in a physical, mechanical revolution of the spindle motor is determined by the number of poles. With 3 phases, a 12 pole motor will have four electrical revolutions for each mechanical revolution of the spindle motor.

The frequency at which the spindle motor 220 is commutated, referred to as the commutation frequency FCOM, is determined as follows:

FCOM=(phases)(poles)(RPM)/60 (1)

A three-phase, 12 pole spindle motor operated at 15,000 revolutions per minute would produce a commutation frequency of:

FCOM=(3)(12)(15,000)/60=9,000 (2)

or 9 kHz. The commutation circuit 212 will thus commutate the spindle driver 216 at nominally this frequency to maintain the spindle motor 202 at the desired operational velocity of 15,000 revolutions per minute (rpm). The foregoing relations can be used to determine the actual motor speed (and therefore speed error) in relation to the frequency at which the zero crossing Zc pulses are provided from the bemf detection circuity 210.

While the prior art circuit of FIG. 3 has been found operable, limitations nevertheless have been found to be associated with this approach. More particularly, in certain circumstances significant current spiking can be observed at or near the commutation switching points. The cause of such spiking can be understood analytically by considering the currents at the center tap 246 of the motor before and after each commutation state change.

For example, assume that the motor 202 is in commutation state AB and about to be changed to state AC at time t=0. Currents IA, IB and IC represent the respective currents in the A, B and C windings 204, 206 and 208.

Summing the currents at time t=0− and t=0+ shows that IA=IB at t=0− (i.e., just before the commutation state change). However, at time t=0+ (i.e., just after the commutation state change), IA=IB+IC.

The current IC passes through the RSENSE resistor 218 and is therefore controlled. When the state switches from AB to AC, the IC component begins rising rapidly in relation to the current command value provided by the DAC 222. The voltage source 240 and the inductance of the motor 202 control the slew rate (dI/dt).

The IB component, however, decays down and circulates back to the voltage source 240 through the diode portion of the BH FET 232. The back electromotive force (bemf) voltage and the inductance of the motor 202 control the rate at which the IB current decays down to zero, and such decay will generally be slower at slower motor speeds.

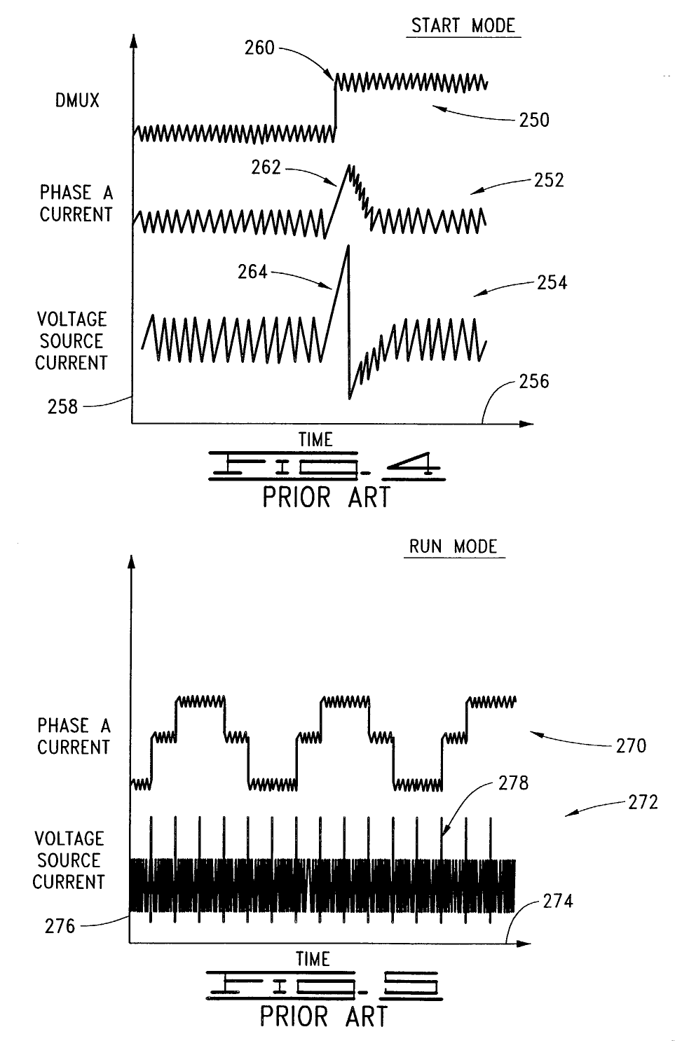

Since the IB current does not pass through the RSENSE resistor 218, the current is not controlled. Hence, IA at time t=0+, which is the sum of the currents IB and IC, is also not initially controlled. Accordingly, undesired current spikes can be observed in both motor current and voltage source current, as shown in FIGS. 4 and 5.

FIG. 4 provides a graphical representation of motor driver characteristics during a start mode in which the motor 202 is accelerated to a nominal operational velocity. FIG. 4 includes a DMUX curve 250, a phase A current curve 252 and a voltage source current curve 254 plotted against a common elapsed time x-axis 256 and a common amplitude y-axis 258.

Because of the foregoing considerations, relatively large current spikes are observed at the DMUX transition 260, including a current spike 262 in the phase A current curve 252 and a current spike 264 in the voltage source current curve 254.

FIG. 5 provides a graphical representation of motor characteristics while operated in a run mode (i.e., at the nominal operational velocity). FIG. 5 includes a phase A current curve 270 and a voltage source current curve 272, plotted against an elapsed time x-axis 274 and a common amplitude y-axis 276. It will be noted that periodic spikes (one denoted at 278) are presented in the voltage source current at or near commutation state changes.

Such current spikes can adversely affect the operation of the disc drive and can damage or impair the ability of the voltage source 240 to provide the required power. The situation is generally worsened if multiple drives are supplied from a common source.

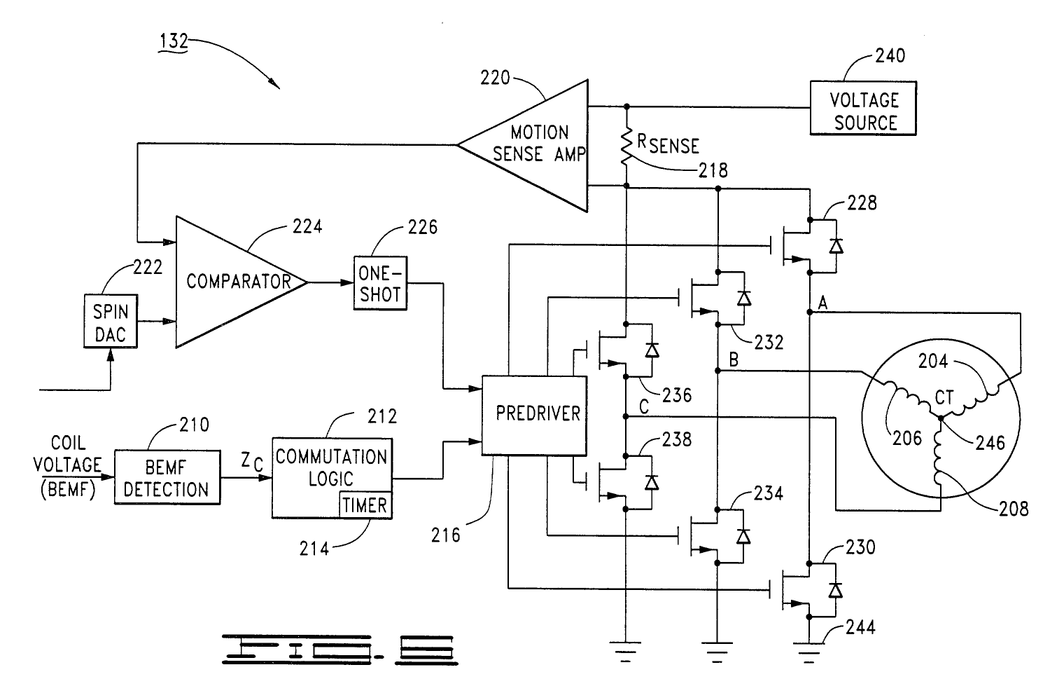

Accordingly, FIG. 6 provides a schematic diagram for the motor driver circuit 132 of FIG. 2 in conjunction with the spindle motor 106 of FIG. 1. It will be noted that similar elements shown in FIGS. 3 and 6 have been provided with identical reference numerals for ease of discussion.

A notable difference between the circuits of FIGS. 3 and 6 includes the location of the R_{SENSE} resistor 218 between the voltage source 240 and the upper FETs 228, 232 and 236 in FIG. 6, as compared to the R_{SENSE.} resistor 218 being located between the lower FETs 230, 234 and 238 and the ground terminal 244 as shown in prior art FIG. 3. This transposition enables the circuit 132 to constantly control the peak current through the respective motor windings 204, 206 and 208 and the peak current from the voltage source 240. The circuit 132 will ensure that both motor and power supply currents will follow the current commanded by DAC 222. Thus, the current demanded by the output of the DAC 222 will generally always be controlled, even at and near commutation switching points.

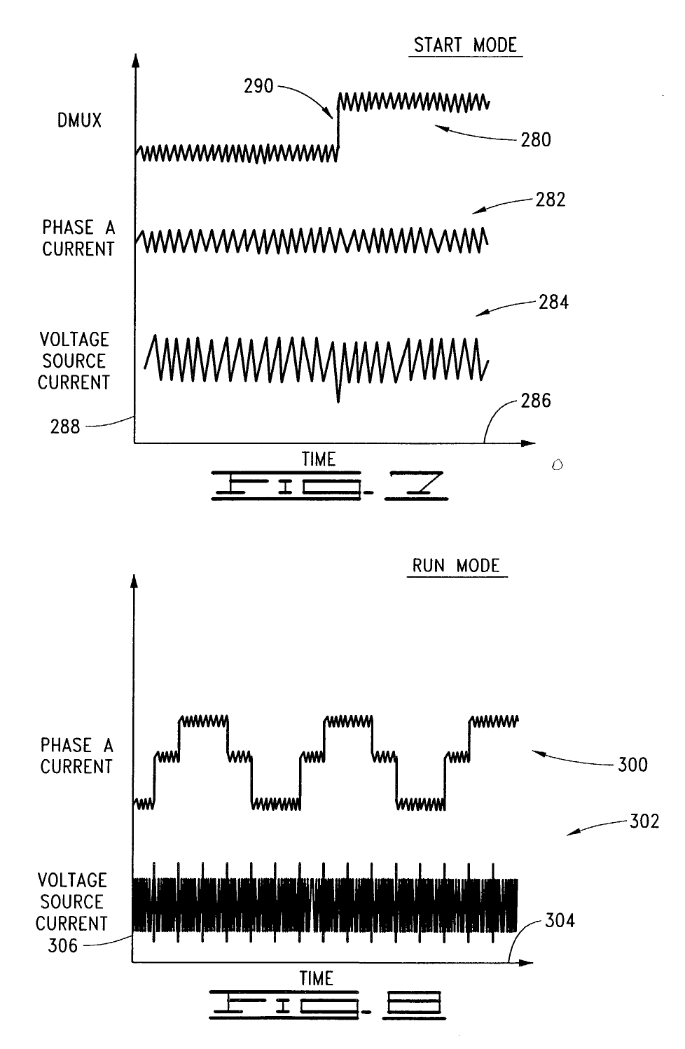

FIGS. 7 and 8 generally illustrate typical results obtained from use of the circuit 132 of FIG. 6. FIG. 7 is a graphical representation to generally illustrate motor characteristics during start mode. FIG. 7 includes a DMUX curve 280, a phase A current curve 282 and a voltage source current curve 284, each plotted against an elapsed time x-axis 286 and a common amplitude y-axis 288.

It will be noted that, unlike the prior art curves of FIG. 4, there are substantially no current spikes in the phase A current curve 282 and in the voltage source current curve 284 at a DMUX line transition 290.

FIG. 8 is a graphical representation to generally illustrate motor characteristics during run mode. FIG. 8 includes a phase A current curve 300 and a voltage source current curve 302 plotted against an elapsed time x-axis 304 and a common amplitude y-axis 306. Unlike the prior art curves of FIG. 5, substantially no current spikes are provided in the voltage source current curve 302.

It will now be appreciated that the configuration of FIG. 6 provides several advantages over the prior art. One advantage is that the voltage across the sense resistor continually represents (and allows control of) the current through the motor 106. This leads to greater stability of the voltage source 240 and reduces the risk of damage thereto. Another advantage is the avoidance of potentially catastrophic breakdowns of the motor. Since motors are typically designed for minimum capacitance, a relatively short duration increase in the current can result in a transient current beyond safe operating limits. The corresponding rise in voltage can cause the device to break down. Control of the current as presented herein substantially reduces the occurrence of such undesired voltage incurred in this condition.

It will now be understood that the present invention (as embodied herein and as claimed below) is generally directed to a motor control circuit (such as 132) which applies current to phases (such as 204, 206, 208) of a multiphase spindle motor (such as 106).

In accordance with preferred embodiments, the motor control circuit comprises a sense resistor (such as 218) connectable to a voltage source (such as 240), the voltage source having a first potential.

A plurality of upper switching elements (such as 228, 232 and 236) are each connected in series between the sense resistor and a different one of the phases of the spindle motor. A plurality of lower switching elements (such as 230, 234 and 238) are each connected in series between a different one of the phases of the spindle motor and a reference terminal (such as 244) having a second potential lower than the first potential.

A driver circuit (such as 216) selectively applies control signals to the switching elements to establish a flow of current from the voltage source, through the sense resistor and to the spindle motor. The control signals are preferably generated in relation to a voltage sensed across the sense resistor.

A commutation circuit (such as 212) is preferably used to electrically commutate the spindle motor over a plurality of commutation states, wherein the control signals are selected in relation to each commutation state. A back electromotive force (bemf) detection circuit (such as 210) preferably detects bemf from the spindle motor and the commutation circuit selects a commutation state in relation to the detected bemf.

The switching elements each preferably comprise a field effect transistor (FET) having a source, a drain and a gate, and wherein the control signals are provided to the gates of the FETs to control source-drain conductivity of said FETs.

The flow of current is preferably passed from the voltage source, through the sense resistor, through a selected upper switching element, through a first phase of the spindle motor associated with the selected upper switching element, through a second phase of the spindle motor, through a selected lower switching element associated with the second phase, and to the reference terminal. The first potential preferably comprises a positive voltage and the second potential of the reference terminal preferably comprises substantially zero volts (i.e., ground).

For purposes of the appended claims, the recited “first means” will be understood as corresponding to the disclosed motor control circuit 132 of FIG. 6 which includes the sense resistor 218 disposed between the voltage source 240 and the spindle motor 106. The recited “first means” will be explicitly defined to exclude prior art motor control circuit configurations such as shown in FIG. 3 wherein the sense resistor is located between the motor and the reference terminal.

It is to be understood that even though numerous characteristics and advantages of various embodiments of the present invention have been set forth in the foregoing description, together with details of the structure and function thereof, this detailed description is illustrative only.

Changes may be made in detail, especially in matters of structure and arrangement of parts within the principles of the invention to the full extent indicated by the broad general meaning of the terms in which the appended claims are expressed. For example, the particular elements may vary depending on the particular application for the motor control circuit while maintaining the same functionality without departing from the spirit and scope of the invention.

In addition, although the embodiments described herein are generally directed to a motor driver circuit for a disc drive data storage device, it will be appreciated by those skilled in the art that the circuit can be used for other devices to operate a rotatable member without departing from the spirit and scope of the claimed invention.

What is claimed is:

1. A motor control circuit which applies current to phases of a multiphase spindle motor, comprising:
a sense resistor connectable to a voltage source, said voltage source having a first potential;
a plurality of upper switching elements each connected in series between the sense resistor and a different one of the phases of the spindle motor;
a plurality of lower switching elements each connected in series between a different one of the phases of the spindle motor and a reference terminal having a second potential lower than the first potential; and
a driver circuit which selectively applies control signals to the switching elements to establish a flow of current from the voltage source, through the sense resistor and to the spindle motor.

2. The motor control circuit of claim 1, wherein the control signals are generated in relation to a voltage sensed across the sense resistor.

3. The motor control circuit of claim 2, further comprising an amplifier coupled to the sense resistor to generate a sensed voltage signal indicative of the voltage sensed across the sense resistor.

4. The motor control circuit of claim 1, further comprising a commutation circuit coupled to the driver circuit and used to electrically commutate the spindle motor over a plurality of commutation states, wherein the control signals are selected in relation to each commutation state.

5. The motor control circuit of claim 1, further comprising a back electromotive force (bemf) detection circuit that detects bemf from the spindle motor, wherein the commutation circuit selects a commutation state in relation to the detected bemf.

6. The motor control circuit of claim 1, wherein the switching elements each comprise a field effect transistor (FET) having a source, a drain and a gate, and wherein the control signals are provided to the gates of the FETs to control source-drain conductivity of said FETs.

7. The motor control circuit of claim 1, wherein the flow of current passes from the voltage source, through the sense resistor, through a selected upper switching element, through a first phase of the spindle motor associated with the selected upper switching element, through a second phase of the spindle motor, through a selected lower switching element associated with the second phase, and to the reference terminal.

8. A data storage device, comprising:
a spindle motor having a plurality of phases;
a data storage disc affixed to the spindle motor;
a voltage source having a first potential; and
a motor control circuit that applies a desired magnitude of current to the motor to rotate the disc at a selected velocity, the motor control circuit comprising a sense resistor connected to the voltage source, a plurality of upper switching elements each connected in series between the sense resistor and a different one of the phases of the spindle motor, a plurality of lower switching elements each connected in series between a different one of the phases of the spindle motor and a reference terminal having a second potential lower than the first potential, and a driver circuit which selectively applies control signals to the switching elements to apply the desired magnitude of current from the voltage source, through the sense resistor and to the spindle motor.

9. The data storage device of claim 8, wherein the motor control circuit further comprises an amplifier coupled to the sense resistor to generate a sensed voltage signal indicative of a sensed voltage across the sense resistor, wherein the control signals are generated in relation to the sensed voltage.

10. The data storage device of claim 8, wherein the motor control circuit further comprises a commutation circuit coupled to the driver circuit and used to electrically commutate the spindle motor over a plurality of commutation states, wherein the control signals are selected in relation to each commutation state.

11. The data storage device of claim 10, wherein the motor control circuit further comprises a back electromotive force (bemf) detection circuit that detects bemf from the spindle motor, wherein the commutation circuit selects a commutation state in relation to the detected bemf.

12. The data storage device of claim 8, wherein the switching elements each comprise a field effect transistor (FET) having a source, a drain and a gate, and wherein the control signals are provided to the gates of the FETs to control source-drain conductivity of said FETs.

13. The data storage device of claim 8, wherein the flow of current passes from the voltage source, through the sense resistor, through a selected upper switching element, through a first phase of the spindle motor associated with the selected upper switching element, through a second phase of the spindle motor, through a selected lower switching element associated with the second phase, and to the reference terminal.

14. The data storage device of claim 8, wherein the first potential is characterized as a positive voltage and the second potential is characterized as a substantially zero voltage.

15. A data storage device, comprising:
a spindle motor having a plurality of phases;
a data storage disc affixed to the spindle motor;
a voltage source having a first potential; and
first means for electrically commutating the spindle motor by selectively applying current from the voltage source to the spindle motor and for reducing transients in the applied current at commutation state transitions.

16. The data storage device of claim 15, wherein the first means comprises a motor control circuit that applies a desired magnitude of current to the motor to rotate the disc at a selected velocity, the motor control circuit comprising a sense resistor connected to the voltage source, a plurality of upper switching elements each connected in series between the sense resistor and a different one of the phases of the spindle motor, a plurality of lower switching elements each connected in series between a different one of the phases of the spindle motor and a reference terminal having a second potential lower than the first potential, and a driver circuit which selectively applies control signals to the switching elements to apply the desired magnitude of current from the voltage source, through the sense resistor and to the spindle motor.

17. The data storage device of claim 16, wherein the motor control circuit further comprises an amplifier coupled to the sense resistor to generate a sensed voltage signal indicative of a sensed voltage across the sense resistor, wherein the control signals are generated in relation to the sensed voltage.

18. The data storage device of claim 16, wherein the switching elements each comprise a field effect transistor (FET) having a source, a drain and a gate, and wherein the control signals are provided to the gates of the FETs to control source-drain conductivity of said FETs.

19. The data storage device of claim 16, wherein the applied current passes from the voltage source, through the sense resistor, through a selected upper switching element, through a first phase of the spindle motor associated with the selected upper switching element, through a second phase of the spindle motor, through a selected lower switching element associated with the second phase, and to the reference terminal.

20. The data storage device of claim 16, wherein the first potential is characterized as a positive voltage and the second potential is characterized as a substantially zero voltage.
